(19) United States
(12) Patent Application Publication
(10) Pub. No.: US 2010/0267536 A1
(43) Pub. Date: Oct. 21, 2010

(54) APPARATUS FOR PROCESSING A MATERIAL WEB BETWEEN TWO COUNTER-ROTATINGLY DRIVEN WORK ROLLS

(75) Inventor: Wolfgang RUOFF, Loerrach (DE)

Correspondence Address: VENABLE LLP, P.O. BOX 34385, WASHINGTON, DC, 20043-9998, US

(73) Assignee: Mueller Martini Holding AG, Hergiswil (CH)

(21) Appl. No.: 12/759,862

(22) Filed: Apr. 14, 2010

(30) Foreign Application Priority Data
Apr. 15, 2009 (EP) 09405064.8

(51) Int. Cl. F16C 13/00

(52) U.S. Cl. 492/15

(57) ABSTRACT

An apparatus for processing a material web between two work rolls driven in counter-rotating directions, which may be used for stamping or printing. The apparatus includes a machine frame and two work rolls positioned inside the machine frame. An axial gap exists between the two work rolls and each work roll includes in an axial direction two ends and two bearing sections respectively positioned on the two ends of the work roll within the machine frame. The apparatus further includes four bearer rings, each of which is arranged on a different bearing section of the two work rolls. The bearer rings include conical running surfaces that roll off against each other in pairs and at least one of the bearer rings is displaceable in the axial direction along at least one of the bearing sections.

### CROSS-REFERENCE TO RELATED APPLICATION

This application claims the priority of European Patent Document No. 09405064.8-1251, filed on Apr. 15, 2009, the subject matter of which is incorporated herein by reference.

### BACKGROUND OF THE INVENTION

The present invention relates to an apparatus for processing a material web between two work rolls driven in counter-rotating directions.

When processing material webs, in particular for printing or rotary stamping, the spacing between the work rolls, meaning the so-called anvil plates or magnetic cylinders, must be maintained precisely. In addition, the spacing should also not change under load and it should furthermore be possible to easily and reproducibly move the cylinders or rolls toward each other or apart while the web is drawn in.

Known apparatuses meet these requirements by using bearer rings as disclosed in European patent document No. 0 295 449 A2 or European patent document No. 0 899 068 A2. Devices of this type have the advantage that the axial spacing between the work rolls can be varied, for example to balance changes caused by heating up, by wear and tear, or by variations in the paper thickness. Until now, adjusting the angle between the axes of the work rolls has been possible only with high expenditure through eccentric positioning of the bearer rings on a work roll.

### SUMMARY

It is an object of the present invention to improve an apparatus of the aforementioned type so that the angle between the axes of the work rolls can be varied in the easiest possible way. In principle, it should be possible to adjust the angle while the apparatus is at a standstill. It is furthermore an object of the invention to permit an adjustment of the angle on one side during the operation of the apparatus.

The above and other objects are accomplished according to one aspect of the invention wherein there is provided an apparatus for processing a material web between two work rolls driven in counter-rotating directions, which may be used for stamping or printing, which, in one embodiment, includes a machine frame; two work rolls positioned inside the machine frame, wherein an axial gap exists between the two work rolls, and wherein each work roll includes in an axial direction two ends and two bearing sections respectively positioned on the two ends of the work roll within the machine frame; and four bearer rings, each of which is arranged on a different bearing section of the two work rolls, wherein the bearer rings include conical running surfaces that roll off against each other in pairs, and wherein at least one of the bearer rings is displaceable in the axial direction along at least one of the bearing sections.

According to another embodiment of the invention, at least one of the bearer rings may be positioned such that it can be displaced in the axial direction on at least one of the bearing sections.

It may be thus possible in a particularly easy manner to change the axial spacing between the work rolls on one side only and thus change the angle of the work roll axes, relative to each other, where it is sufficient for only one of the bearer rings to be axially displaceable.

Changing the axial spacing between the work rolls on one side may only allow a more flexible operation as compared to a forced two-sided change of the axial spacing. As a result, only one work roll may be displaced to the side in an axial direction while the other work roll may remain axially fixed.

It may also be useful to provide axially displaceable bearer rings on both sides, so that the work rolls no longer need to be displaced relative to each other in the axial direction to achieve a parallel change in the axial spacing.

According to another embodiment, it may be furthermore advantageous that the bearer ring which may be axially displaceable on one side continues to be coaxial to the work roll and need not be positioned eccentric on the work roll, as is the case with apparatuses as disclosed in the prior art. According to this embodiment of the invention, the bearer rings rotate jointly with the work roll, thus avoiding involved bearing arrangements.

The apparatus according a further embodiment is provided with a positioning device for moving the bearer ring in the axial direction to a different position, relative to the work roll, and for securing the bearer ring in this new axial position.

A device of this type may permit a reproducible repositioning of the bearer ring in the axial direction, without having to remove the bearer ring in a separate and involved step and without having to reattach it to the work roll.

The positioning device of one embodiment comprises an actuator which may be secured in an axial direction at least indirectly to the bearer ring.

According to another embodiment, the positioning device may be provided with a bolt that is arranged centrally in the work roll and is axially displaceable in the work roll, as well as with a connecting element between the bolt and the bearer ring. The connecting element may secure the bearer ring relative to the bolt. In particular, the connecting element may extend radially through the bolt and into the bearer ring. The connecting element may connect the bolt and the bearer ring torque proof with the work roll. The actuator may be secured to the bearer ring in the axial direction with the aid of the bolt and the connecting element.

The repositioning in the axial direction of the bearer ring can thus be realized cost-effectively and easily with an optional actuator that acts upon the bearer ring via the easy to produce bolt and the simple arrangement of the connecting element, relative thereto.

The aforementioned embodiments are relevant for optional operating states of the apparatus because they take into account a repositioning during the standstill as well as during the operation of the apparatus, meaning while the rolls are rotating.

According to another embodiment of the positioning device for changing the axial position of the bearer ring during the standstill of the apparatus, an actuator in the form of a setscrew may be provided. The setscrew may extend axially in the work roll and may be embodied in the axial direction on the inside with an external thread that engages in a corresponding internal thread of the bolt, wherein a tool can be used to turn the setscrew.

The actuator in the particularly simple form of a setscrew may cause an axial displacement of the bearer ring as a result of the secure transfer of a rotational movement of the setscrew which is converted into a translatory movement of the bolt via the above-described threaded engagement, wherein the displacement can be controlled from the outside. The bearer ring can remain torque proof in its position directly on the work roll, meaning only the displacement in the axial direction must be ensured. These configurations for positioning the bearer rings can be produced especially cost-effectively.

According to one embodiment of the device for repositioning the bearer ring while the processing apparatus is stopped, a hexagon socket may be formed onto an axially outer end of the setscrew, wherein the edges of the hexagon socket extend in the axial direction. A tool provided with a hexagon socket wrench can thus be used to turn the setscrew.

Embodying the setscrew in this way may make it possible to turn it with a simple tool and with little wear and tear.

According to a another embodiment, the positioning device for the repositioning during the standstill of the apparatus may be provided with a setscrew with a circular collar. The collar may be positioned axially inside the work roll with the aid of at least one ring-shaped element, in particular with the aid of two retaining rings located on both sides adjacent to the collar.

Positioning the setscrew in the work roll by placing the collar between two axial supports may result in a particularly simple structural design.

The axial position of the setscrew may be therefore fixed in a simple manner in the work roll while the bolt, which is axially displaceable inside the work roll, may move axially toward the inside or the outside during the rotation of the setscrew. A setscrew of this type generally turns along with the work roll during the apparatus operation, so that the positioning is not affected.

The locking in place of the setscrew position with the aid of ring-shaped elements, in particular retaining rings, can be released easily if the setscrew must be removed, for example for maintenance purposes.

One embodiment of the device for adjusting the axial position of the bearer ring while the apparatus is operational comprises a flange and a therein guided adjusting spindle that may function as an actuator.

The flange may be arranged coaxial to the work roll, in the axial direction on the outside of the machine frame. In particular, the flange may be screwed to the frame and may have a centrally extending internal thread. The adjusting spindle may be secured in the bolt, in an axial direction on the inside. In a center section in the axial direction, the adjusting spindle may have an external thread that engages in the internal thread of the flange. An adjustment element which can be used to turn the spindle may be arranged at one outer end of the adjusting spindle, as seen in the axial direction. The adjustment element may be embodied as a manually operated wheel, wherein the wheel is only one example of equally effective manually operated adjustment elements. Of course, hydraulic, electric or pneumatic embodiments of the adjustment element can also be used, wherein these alternative adjustment elements permit a remote-controlled repositioning.

This simple actuator may also act via a simple configuration of bolt and connecting element onto the bearer ring. The flange provided can be attached without a problem to the existing machine frame, so that the construction of the machine frame does not need to be changed.

One embodiment of the apparatus provides that outside of the flange, the adjusting spindle may be surrounded axially by a locking nut. In a radial direction, the locking nut contains at least one bore into which a clamping element is inserted, wherein this clamping element acts upon the adjusting spindle.

The axial position of the locking nut on the adjusting spindle may thus be fixed. The adjusting spindle cannot be screwed counter to the resistance of the locking nut in the axial direction into the apparatus if the locking nut fits flush against the machine frame. By securing an arrangement in this way with a locking nut, it is easily possible to fixate the axial position of the bolt in the work roll, wherein an accidental displacement caused by an unintended turning of the adjustment element is prevented.

According to another embodiment of the apparatus, the adjusting spindle may be provided with a circumferential collar on an inside end in the axial direction. The collar may be positioned axially extending inside the bolt with the aid of at least one ring-shaped element.

Since the bolt turns jointly with the work roll during the operation and a connection exists between the bolt and the coaxially arranged, stationary adjusting spindle, the bolt may be provided with a corresponding bearing for the adjusting spindle in order to accommodate the adjusting spindle in the axial direction. Standard roller bearings can be used for this, which are arranged on both sides of the collar which can have a particularly simple design. An inside roller bearing may thus be supported in the bolt while an outside roller bearing may be supported in an especially cost-effective manner by a ring-shaped element, especially a retaining ring.

Particularly advantageous is the use of such devices in printing machines.

### BRIEF DESCRIPTION OF THE DRAWINGS

These and other features and advantages of the invention will be further understood from the following detailed description when read in conjunction with the accompanying drawings, in which:

FIG. 1a is a sectional view in an axial direction through one end of a work roll, provided with a positioning device for the axial repositioning of a bearer ring during the standstill of the apparatus, wherein the bearer ring is moved to an inside position in the axial direction, according to the invention;

FIG. 1b is a sectional view in an axial direction though the section of the apparatus shown in FIG. 1a, following a 90° rotation;

FIG. 1c is a view from above of the work roll according to FIGS. 1a and 1b;

FIG. 2a is a sectional view in an axial direction through the apparatus section shown in FIG. 1a, wherein the bearer ring is moved to an outer position in the axial direction;

FIG. 2b is a sectional view in an axial direction though the section of the apparatus shown in FIG. 2a, following a 90° rotation;

FIG. 2c is a view from above of the work roll according to FIGS. 2a and 2b;

FIG. 3a is a sectional view in an axial direction though a segment of the end of a work roll, positioned inside a machine frame and provided with a positioning device for the axial repositioning of the bearer ring while the apparatus is operational, wherein the bearer ring is displaced to an inner position in the axial direction, according to the invention;

FIG. 3b is a sectional view in an axial direction though the apparatus section shown in FIG. 3a, following a 90° rotation;

FIG. 4a is a sectional view in an axial direction through the apparatus section shown in FIG. 3a, wherein the bearer ring is moved to an outer position in the axial direction;

FIG. 4b is a sectional view in an axial direction though the section of the apparatus shown in FIG. 4a, following a 90° rotation;

FIG. 5 is a frontal view of the apparatus, according to the invention.

### DETAILED DESCRIPTION

The same components are given the same reference numbers, but not all reference numbers are provided in all the Figures in order to ensure a better overview.

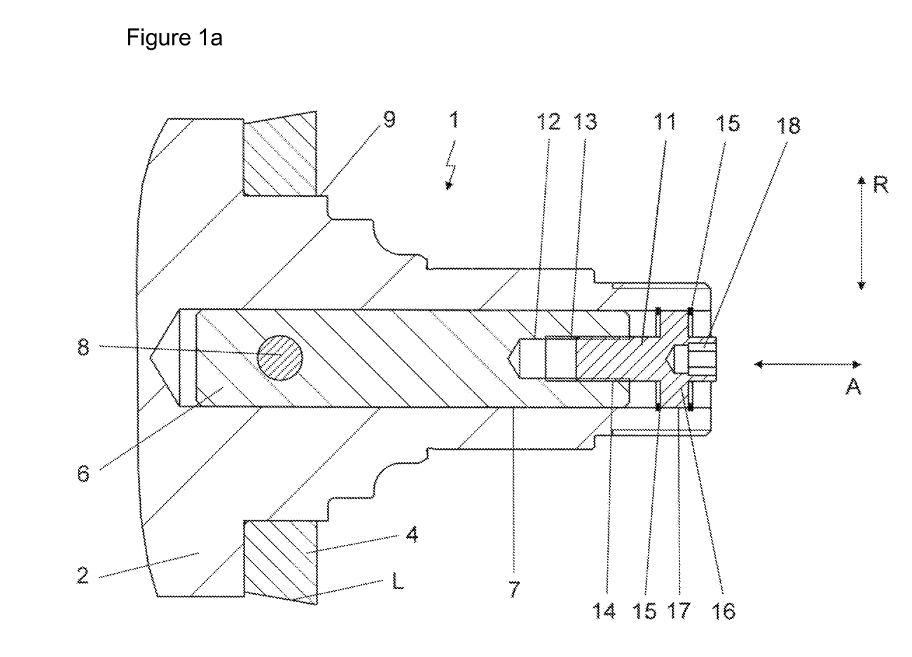

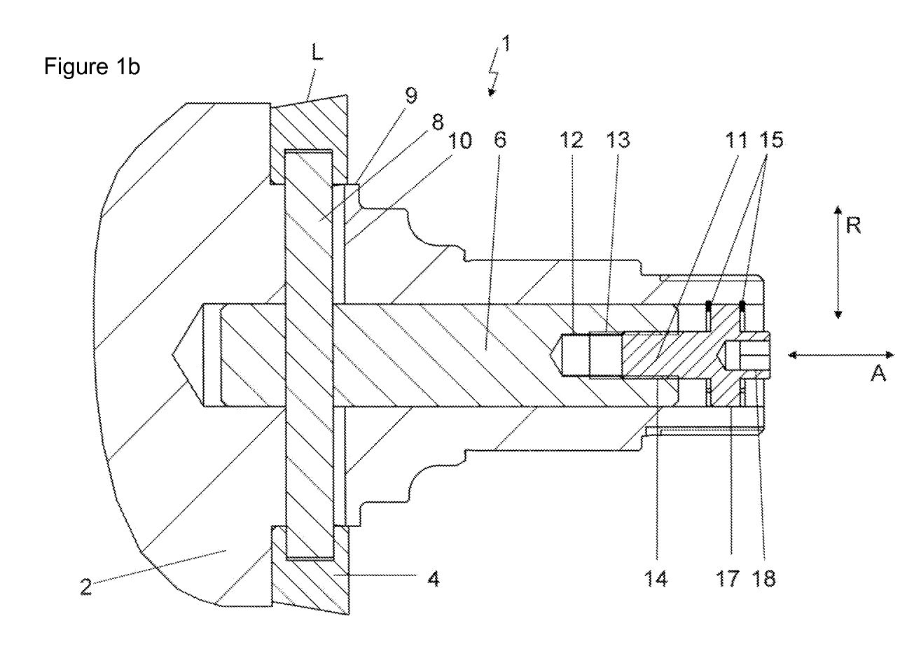

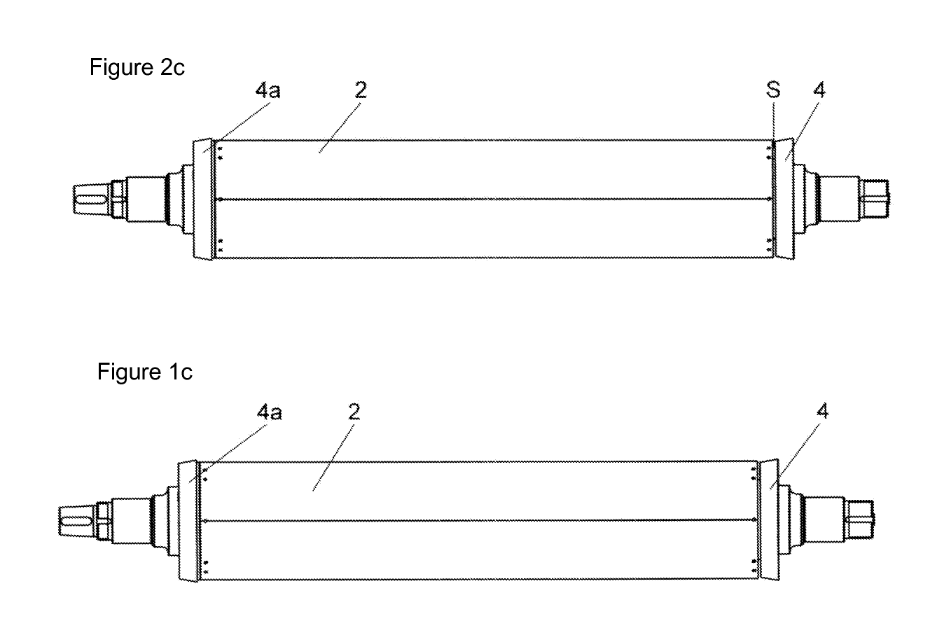

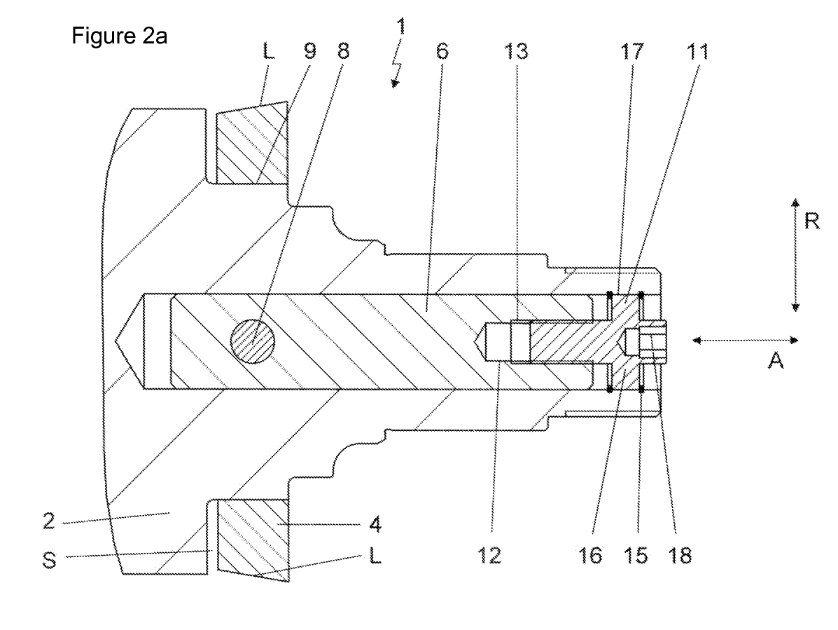

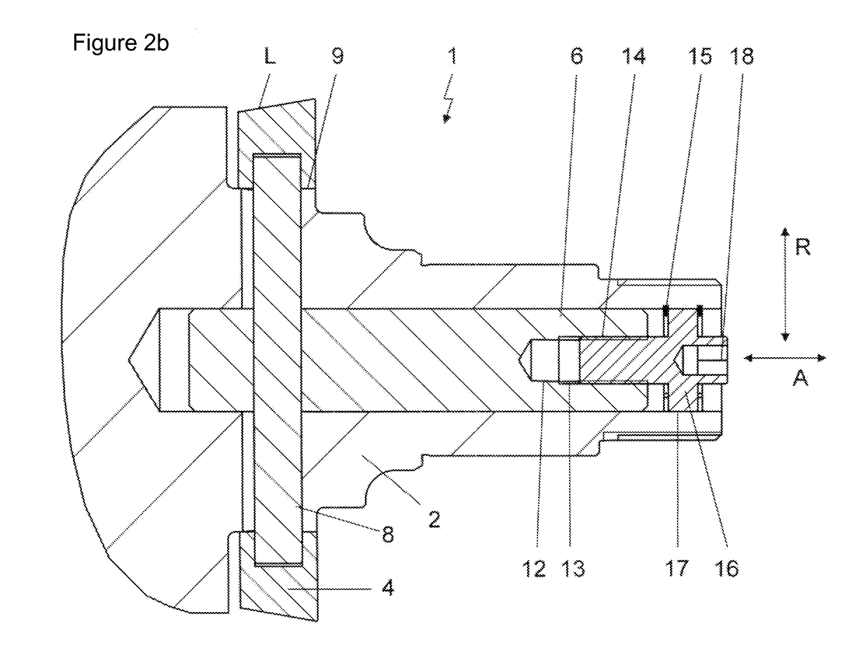

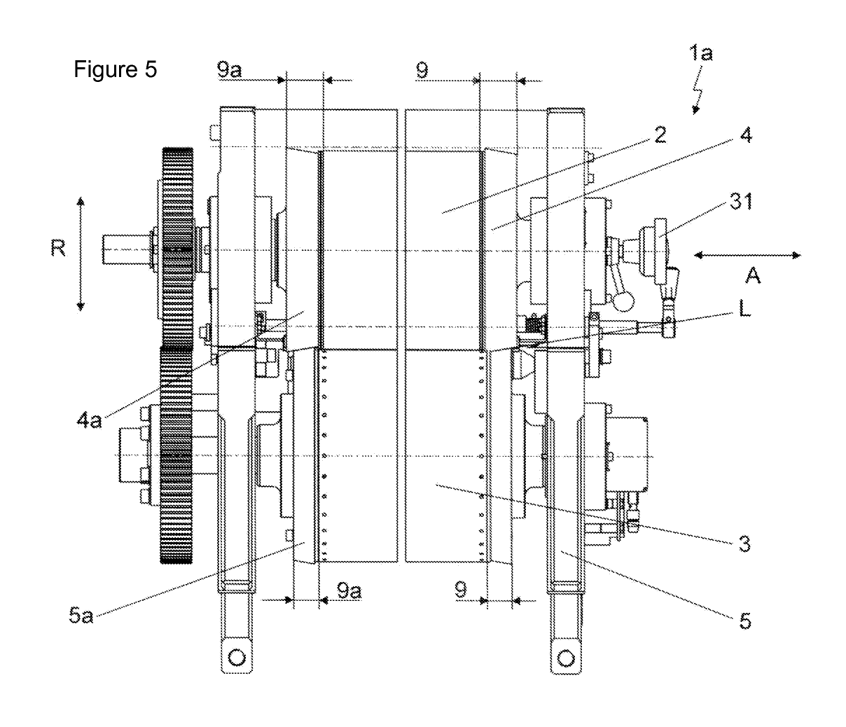

FIGS. 1a to 2c show a first embodiment of a positioning device 1 according to the invention, which is used in an apparatus for processing a material web between two counter-rotatingly driven work rolls 2, 3. The positioning device 1 is intended for changing the angle between the axes of the work rolls 2, 3 while the work rolls 2, 3 are standing still. FIGS. 1a, 1b, 2a, 2b only show one end of one of the work rolls 2 where the axial position of a bearer ring 4 can be adjusted with the aid of the positioning device 1. In a radial direction on the outside, the bearer ring 4 has a conical running surface L. The conical shape of the running surface L takes into consideration the design of a bearer ring 5 that is correspondingly arranged on the counter-rotating work roll 3. Even though the device according to the first embodiment is not shown in a corresponding overview, FIG. 5 nevertheless illustrates the arrangement of the bearer rings 4, 4a, 5, 5a on the bearing sections 9, 9a of the work rolls 2, 3.

The positioning device 1 comprises a bolt 6 which is guided axially displaceable inside an axial recess 7 of the work roll 2. A connecting element 8 extends perpendicular through the bolt 6, meaning in a radial direction R. The connecting element 8 also extends in a radial direction R through a bearing section 9 of the work roll 2, wherein a surface of the bearing section 9 is embodied cylindrical for accommodating the axially displaceable bearer ring 4. A radially extending through opening 10 for accommodating the connecting element 8 is embodied in the work roll 2, in an inside region of the bearing section 9. The through opening 10 is dimensioned such that the connecting element 8 can be moved with play in an axial direction A inside the work roll 2. The connecting element 8 engages with its ends into the bearer ring 4.

All components, starting with the bolt 6 up to the bearer ring 4, are therefore positioned torque proof in or on the work roll 2.

An actuator in the form of a setscrew 11 is used for axially repositioning the bolt 6 in the work roll 2. Axially on the outside, the bolt 6 is provided for this with a blind hole 12, arranged coaxial to the work roll 2, which has an internal thread 13. The setscrew 11 is provided axially on the inside with an external thread 14 that corresponds to the internal thread 13 of the bolt 6.

The setscrew 11 is supported on both sides in the axial direction in the work roll 2 with the aid of ring-shaped elements 15 embodied as retaining rings. The setscrew 11 is provided for this with a circumferential collar 16 which in turn has a bearing location 17, embodied to function as sliding bearing together with the axial recess 7 on the work roll 2.

A hexagon socket 18 is embodied axially on the outside end of the setscrew 11, so that the setscrew 11 can be turned with the aid of a standard tool. By correspondingly turning the setscrew 11, the bearer ring 4 is moved in the axial direction toward the inside or the outside, relative to the work roll 2, when the apparatus is at a standstill.

FIGS. 1a to 1c show a bearer ring 4 in an axial inside position in which the ring is supported against the work roll 2. By turning the setscrew 11, the bearer ring 4 is pulled axially toward the outside, so that a gap S forms in the radial direction on the outside between the work roll 2 and the bearer ring 4, as shown in FIGS. 2a and 2b. The running surface L has a conical shape, so that during the axial displacement of the bearer ring 4 the two work rolls 2, 3, which roll off against each other, move toward each other or move away from each other on the side of the positioning device 1, meaning the axial spacing between the work rolls 2, 3 is accordingly changed on one side during the standstill of the work rolls 2, 3.

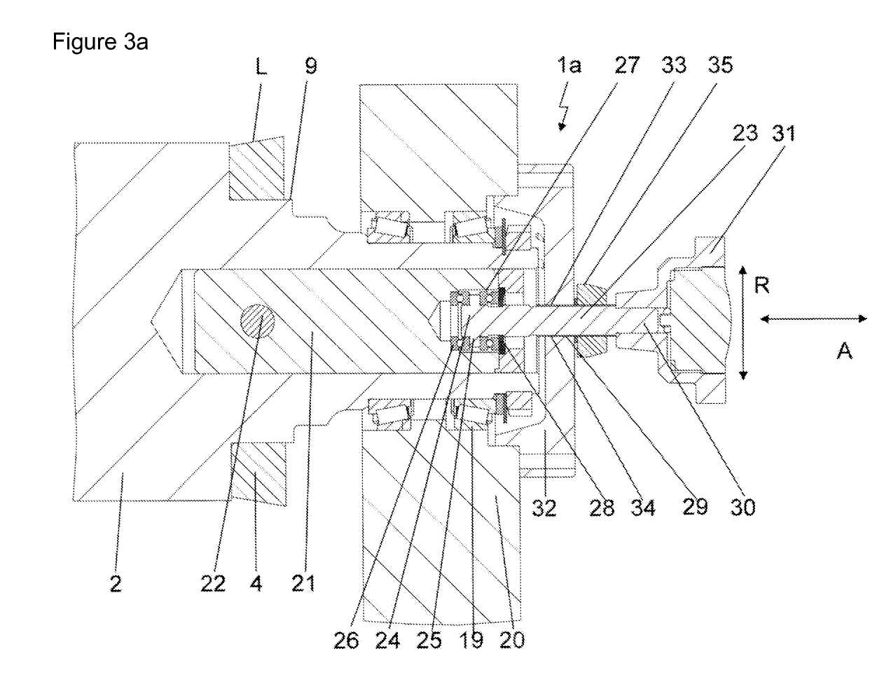

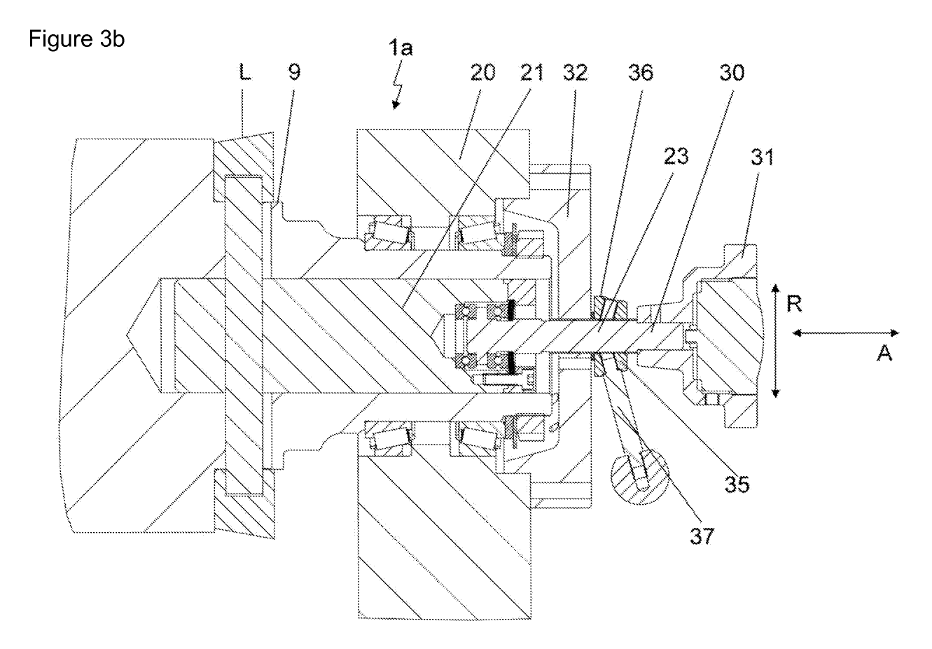

FIGS. 3a to 5 contain a second embodiment of a positioning device 1a, wherein the work roll 2 is held with the aid of roller bearings 19 in a machine frame 20. In the same way as for the first embodiment of the positioning device 1, the axial repositioning of the bearer ring 4 is again realized with the aid of a bolt 21 that is connected via a connecting element 22 to the bearer ring 4. However, the positioning device 1a is suitable for changing the angle between the axes of the work rolls 2, 3 while the apparatus is operational.

An actuator 23 that is embodied as adjusting spindle is used to move or displace the bolt 21 in the axial direction to a different position. The adjusting spindle is positioned with an inside end 24 in the axial direction inside the bolt 21 and comprises a collar 25, which projects radially outward from the axial inside end 24 of the adjusting spindle. The collar 25 is supported on both sides on roller bearings 26, 27 and is surrounded in the radial direction R by the bolt 21, at a distance thereto. The inside roller bearing 26 in the axial direction is supported against the bolt 21 while the outside roller bearing 27 in the axial direction is secured relative to the bolt 21 with the aid of a ring-shaped element 28. The bolt 21 can thus be rotated in a coaxial direction around the adjusting spindle, but is held in place in the axial direction by the adjusting spindle.

As seen in the axial direction, the adjusting spindle is provided with an external thread 29 in a central region and with an adjustment element 31 on one outer end 30. The adjustment element 31 in particular is embodied as manually-operated wheel, wherein electric, pneumatic or hydraulic embodiments of the adjustment element 31 are also suitable for adjusting the actuator 23 via remote control.

Coaxial to the adjusting spindle, a flange 32 is arranged in the axial direction on the outside of the machine frame 20 and contains a central bore 33 with an internal thread 34. The adjusting spindle engages with its external thread 29 in the internal thread 34 of the flange 32.

A rotation of the adjusting spindle causes it to be displaced in the axial direction A. Since the bolt 21 is fixed in the axial direction, relative to the adjusting spindle, a turning of the adjustment spindle consequently causes a displacement of the bolt 21 in the axial direction A.

A locking nut 35 surrounds the adjusting spindle in the axial direction on the outside of the flange 32. The locking nut 35 is provided with openings 36, embodied to extend radially at an angle toward the outside, into which a clamping element 37 can be inserted. If the clamping element 37 is screwed into the locking nut 35 until it reaches the external thread 29 of the adjusting spindle and fits flush against the machine frame 20, it prevents a further and unintended screwing in of the adjusting spindle in the radial direction toward the inside, which could happen during an accidental actuation of the adjustment element 31. The locking nut 35 can furthermore be used to maintain or to mark an especially suitable position for the adjusting spindle.

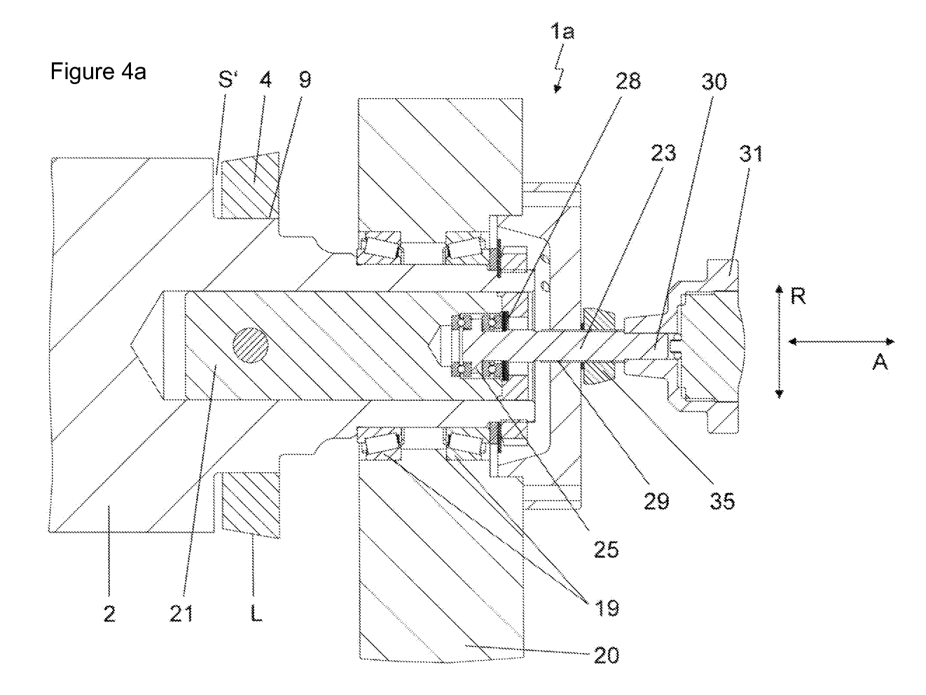

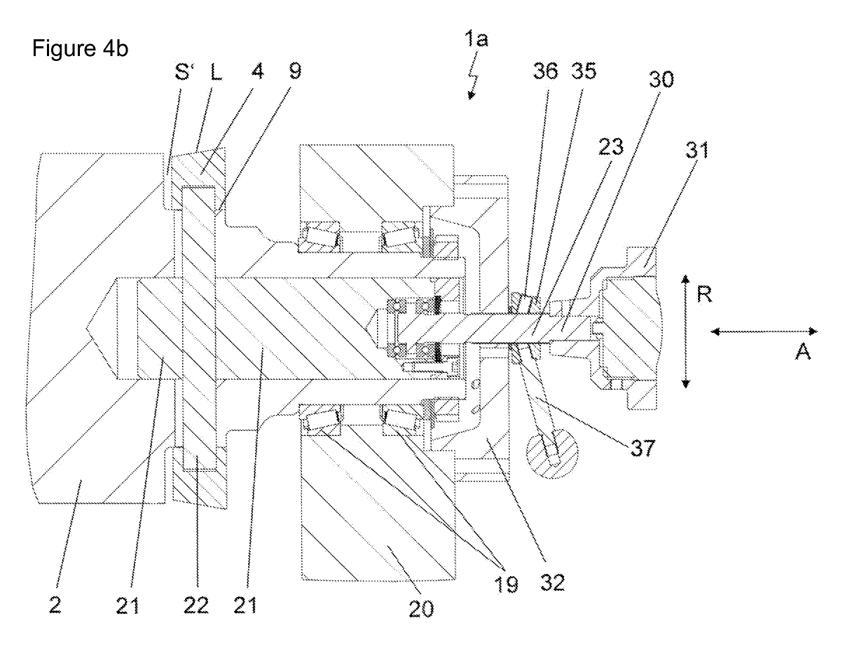

In FIGS. 3a and 3b, the bearer ring 4 is shown in the axial inside position where it fits flush against the work roll 2. By turning the adjusting spindle, the bearer ring 4 can be displaced axially toward the outside to a position where it is spaced apart from the work roll 2 by a gap S′, as shown in FIGS. 4a and 4b. This is a particularly advantageous option when the apparatus is operational, meaning while the work roll 2 rotates. The bearer ring 4, the connecting element 22 and the bolt 21 rotate jointly with the work roll 2. In contrast, the machine frame 20, the flange 32 and the adjusting spindle do not rotate because they are disconnected via the roller bearings 19, 26, 27.

It will be understood that the above description of the present invention is susceptible to various modifications, changes and adaptations, and the same are intended to be comprehended within the meaning and range of equivalents of the appended claims.

What is claimed is:

1. An apparatus for processing a material web between two work rolls driven in counter-rotating directions, which may be used for stamping or printing, the apparatus comprising:
a machine frame;
two work rolls positioned inside the machine frame, wherein an axial gap exists between the two work rolls, and wherein each work roll includes in an axial direction two ends and two bearing sections respectively positioned on the two ends of the work roll within the machine frame; and
four bearer rings, each of which is arranged on a different bearing section of the two work rolls, wherein the bearer rings include conical running surfaces that roll off against each other in pairs, and wherein at least one of the bearer rings is displaceable in the axial direction along at least one of the bearing sections.

2. The apparatus according to claim 1, further comprising at least one positioning device to displace the bearer rings relative to their respective work roll, in the axial direction, to a different axial position, wherein the bearing rings are securable in the different axial position.

3. The apparatus according to claim 2, wherein the at least one positioning device comprises an actuator which is secured, in the axial direction, at least indirectly on at least one of the bearer rings.

4. The apparatus according to claim 3, wherein the at least one positioning device further comprises:
a bolt that is displaceable axially in one of the two work rolls; and
a connecting element positioned between the bolt and at least one bearer ring,
wherein the connecting element radially extends through the bolt and into the at least one bearer ring to secure the at least one bearer ring relative to the bolt in the axial direction, and
wherein the connecting element and the bolt further secure the actuator in the axial direction on the at least one bearer ring.

5. The apparatus according to claim 4, wherein the bolt includes an internal thread and the actuator comprises a setscrew including an external thread, wherein the setscrew is positioned axially in one of the two work rolls, and wherein the external thread of the setscrew engages with the corresponding internal thread of the bolt.

6. The apparatus according to claim 5, wherein the actuator has an outer end that includes an axially extending hexagonal socket.

7. The apparatus according to claim 5, wherein the actuator includes a circumferential collar that is positioned axially in the work roll via at least one ring-shaped element.

8. The apparatus according to claim 4, wherein the positioning device includes a flange that is arranged in a position coaxial to at least one of the two work rolls in the axial direction on an outside of the machine frame,
wherein the flange includes an internal thread which extends through the center of the flange,
wherein the actuator comprises an adjusting spindle having an external thread which is positioned with an inside end axially in the bolt,
wherein the external thread of the adjusting spindle engages with the internal thread of the flange in an axial center section, and
wherein the actuator has an outside end including an adjustment element.

9. The apparatus according to claim 8, further including a locking nut surrounding the actuator on a side of the flange remote from the bolt, wherein the locking nut includes at least one opening in an approximately radial direction into which a clamping element is insertable for acting on the clamping element.

10. The apparatus according to claim 8, wherein the actuator includes a circumferential collar on an axially inside end of the actuator; and a ring-shaped element to position the circumferential collar in the axial direction on the inside of the bolt.

11. A printing machine comprising the apparatus according to claim 1.

12. The apparatus according to claim 7, wherein the at least one ring-shaped element comprises two retaining rings located on either side of the circumferential collar.

13. The apparatus according to claim 10, wherein the at least one ring-shaped element comprises a retaining ring.
